(19) United States
(12) Patent Application Publication
(10) Pub. No.: US 2021/0254768 A1
(43) Pub. Date: Aug. 19, 2021

(54) STAPLE-LOCK COUPLING

(71) Applicant: Caterpillar Inc., Peoria, IL (US)

(72) Inventor: Bailey Justin FERKEL, Menominee, MI (US)

(73) Assignee: Caterpillar Inc., Peoria, IL (US)

(21) Appl. No.: 16/793,893

(22) Filed: Feb. 18, 2020

(51) Int. Cl. F16L 37/12

(52) U.S. Cl. CPC F16L 37/1225

(57) ABSTRACT

A connection includes a male piece configured to permit insertion into a female piece. The male piece includes an open surface extending through the male piece to permit a fluid to be communicated through the male piece and an external recessed surface portion. When the male piece is inserted into the female piece, the external recessed surface portion is aligned with an open surface extending through the female piece to form an opening extending through the connection. The opening is configured to allow a leg of a staple to be inserted through the opening to couple the male piece and the female piece together. The external recessed surface portion forms a cavity under a portion of the leg of the staple to prevent an edge of the leg of the staple from contacting the external recessed surface portion when the leg of the staple extends through the opening.

### TECHNICAL FIELD

The present disclosure relates generally to a connection or coupling device included in a coupling assembly and to a male hydraulic coupling device, included in a hydraulic coupling assembly, having an improved groove profile for retaining a U-shaped staple.

### BACKGROUND

A staple-lock coupling can be used to connect hydraulic fluid-based power transmission systems. The staple-lock coupling includes two mating parts (e.g., a male piece and a female piece) that are configured to be connected in a fluid tight relationship. An exterior surface of the male piece of the staple-lock coupling includes an annular groove formed thereon which, when the male piece is connected to the female piece, aligns with a staple receiving bore formed through the female piece. The alignment of the annular groove and the staple receiving bore forms an opening through which a leg of a staple can be inserted to prevent relative axial displacement of the male and female pieces.

The staple leg has a D cross-sectional configuration and, when inserted through the opening, a rounded surface of the leg of the staple is adjacent to a surface of the female piece forming the staple receiving bore and a flat surface of the staple leg is adjacent to a flat exterior surface of the male piece forming the annular groove. During use, when the male and female pieces attempt to move apart, a force may be exerted on the flat exterior surface of the male piece and/or the leg of the staple causing wear and fatigue to the male piece and/or the leg of the staple.

One attempt to reduce the wear and fatigue associated with the staple-lock coupling is disclosed in U.S. Pat. No. 6,290,263 that issued to Murken on Sep. 18, 2001 (“the '263 patent”). In particular, the '263 patent discloses a detachable hose coupling having an interlocking U-shaped staple. The U-shaped staple has a cross-section with a peripheral surface which includes at least one radially recessed surface portion to permit a predetermined amount of fluid flow when inserted into the male-female coupling.

While the U-shaped staple of the '263 patent may reduce brinelling in the surfaces of the male and female pieces forming the opening, the '263 patent does not address the wear and fatigue of the male piece and/or the staple due to a force being exerted on the flat exterior surface of the male piece and/or the leg of the staple when the male and female pieces attempt to move apart.

The staple-lock coupling of the present disclosure solves one or more of the problems set forth above and/or other problems in the art.

### SUMMARY

According to some implementations, a connection may include a male piece of a detachable hose coupling configured to permit insertion into a female piece of the detachable hose coupling, wherein the male piece includes: a longitudinal axial open surface extending through the male piece to permit a fluid to be communicated through the male piece, and an external recessed surface portion, wherein, when the male piece is inserted into the female piece, the external recessed surface portion is aligned with an open surface extending through the female piece to form an opening extending through the detachable hose coupling, wherein the opening is configured to allow a leg of a staple to be inserted through the opening to couple the male piece and the female piece together, and wherein the external recessed surface portion forms a cavity under a portion of the leg of the staple to prevent an edge of the leg of the staple from contacting the external recessed surface portion when the leg of the staple extends through the opening to couple the male piece and the female piece together.

According to some implementations, a connection may include a male piece of a detachable hose coupling comprising a shape that allows the male piece to be inserted into a female piece of the detachable hose coupling, wherein the male piece includes: a first end coupled to a conduit; a longitudinal axial open surface extending from the first end to a second end of the male piece to permit a fluid, received via the conduit, to be communicated through the male piece, and an external recessed surface portion, wherein, when the male piece is inserted into the female piece, the external recessed surface portion is aligned with an open surface extending through the female piece to form an opening extending through the detachable hose coupling, wherein the opening is configured to allow a leg of a staple to be inserted through the opening to couple the male piece and the female piece together, and wherein the external recessed surface portion is shaped to prevent an edge of the leg of the staple from contacting the external recessed surface portion when the leg of the staple extends through the opening.

According to some implementations, a detachable hose coupling may include a male piece configured to permit insertion into a female piece of the detachable hose coupling, wherein the male piece includes: a longitudinal axial open surface extending through the male piece to permit a fluid to be communicated through the male piece, and an external recessed surface portion, wherein, when the male piece is inserted into the female piece, the external recessed surface portion is aligned with an open surface extending through the female piece to form an opening extending through the detachable hose coupling, wherein the opening is configured to allow a leg of a staple to be inserted through the opening to couple the male piece and the female piece together, and wherein the external recessed surface portion forms a recessed area under a portion of the leg of the staple to prevent a first edge of the leg of the staple from contacting the external recessed surface portion when the leg of the staple extends through the opening to couple the male piece and the female piece together.

### BRIEF DESCRIPTION OF THE DRAWINGS

FIG. 1 is a diagram of an example coupling device.

FIG. 2 is a diagram of an exploded view of an example coupling device.

FIG. 3 is a diagram of an example sectional view of the coupling device of FIG. 1.

FIG. 4 is a diagram of an example sectional view of the coupling device of FIG. 2.

### DETAILED DESCRIPTION

This disclosure relates to a coupling device and coupling assemblies. The coupling device has universal applicability to any machine utilizing fluid power transfer. The term “machine” may refer to any machine that performs an operation associated with an industry such as, for example, mining, construction, farming, transportation, robotics, or any other industry. As some examples, the machine may be a vehicle (e.g., a car, a truck, a boat, a helicopter, an airplane, etc.), a robotic machine, a backhoe loader, a cold planer, a wheel loader, a compactor, a paver, a forest machine, a forwarder, a harvester, an excavator, an industrial loader, a tractor, a dozer, or another type of mining, construction, farming, robotic, and/or transportation equipment.

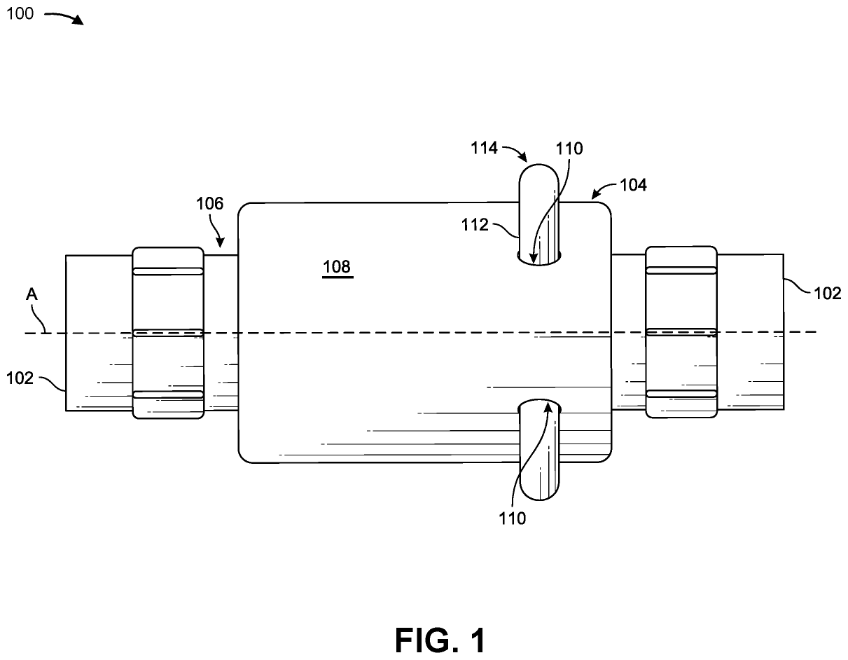

FIG. 1 is a diagram of an example coupling device 100. In some implementations, the coupling device 100 is configured to couple (e.g., join, connect, attach, etc.) to a fitting (not shown), whereby the coupling device 100 and the fitting may collectively engage a hose 102, a tube, a component, a conduit, and/or the like for facilitating a fluid connection between the hose 102 and a port (not shown) of a hydraulic system, such as a hydraulic system including, without limitation, a motor, a pump, a generator, an accumulator, a hydraulic cylinder, and/or the like. The port may be connected to any type of system consistent with the instant disclosure.

The coupling device 100 includes a female piece 104 and a male piece 106. The female piece 104 has a generally cylindrical outer surface 108 forming a recess for receiving the male piece 106. The female piece 104 includes a pair of coaxially aligned and bored open surfaces 110 (two of which are shown in FIG. 1). The open surfaces 110 are generally equidistant and opposing positions about a horizontal plane passing through an axial axis A of the coupling device 100.

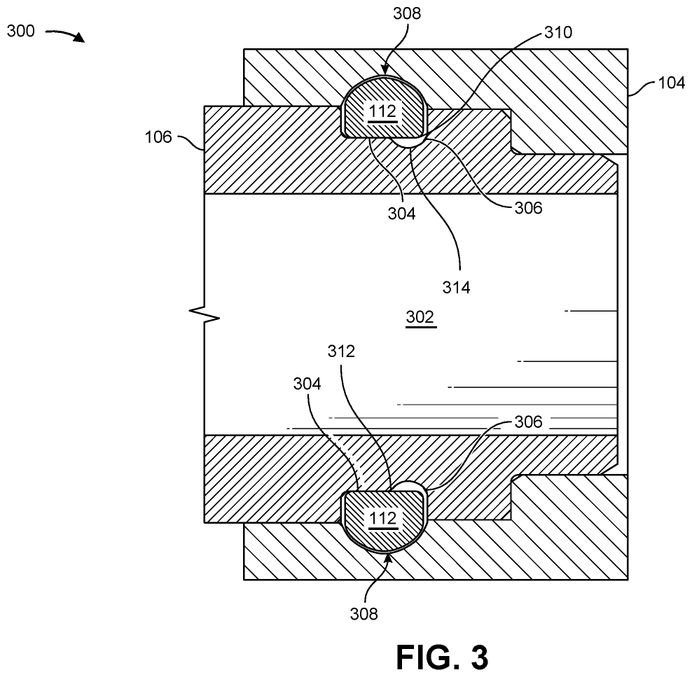

The male piece 106 has a generally cylindrical shape and is configured to be received within the recess formed by the outer surface 108 of the female piece 104. The male piece 106 includes an interior surface (see, e.g., reference number 302, FIG. 3) forming a hollow cavity extending therethrough to permit fluid communication with a hose 102, as described above.

The male piece 106 includes an external recessed surface portion (see, e.g., reference number 304, FIG. 3) that, when the male piece 106 is inserted into the female piece 104, aligns with the open surfaces 110 to form an opening (see, e.g., reference number 308, FIG. 3) through which a leg 112 of a staple 114 can be inserted to couple the male piece 106 and the female piece 104 together, as shown in FIG. 1.

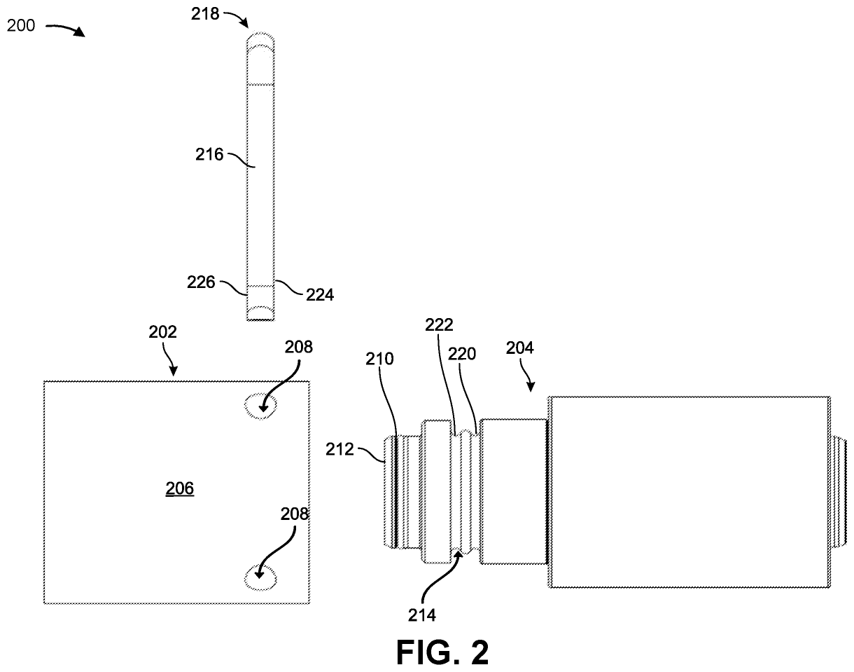

FIG. 2 is a diagram of an exploded view of an example coupling device 200. The coupling device 200 includes a female piece 202 and a male piece 204. The female piece 202 has a generally cylindrical outer surface 206 forming a recess for receiving the male piece 204. The female piece 202 includes a pair of coaxially aligned and bored open surfaces 208 (two of which are shown in FIG. 2). The open surfaces 208 are generally equidistant and opposing positions about a horizontal plane passing through an axial axis of the coupling device 200.

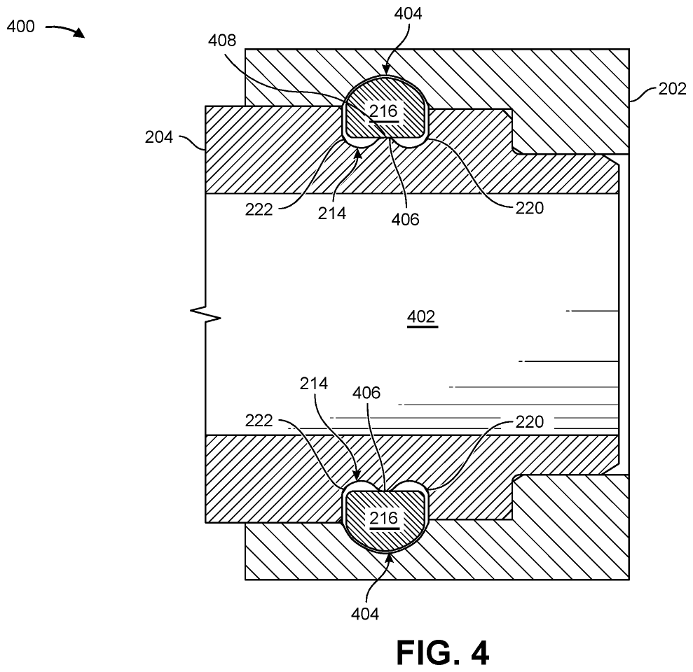

The male piece 204 has a generally cylindrical shape and is configured to be received within the recess formed by the outer surface 206 of the female piece 202. The male piece 204 includes an interior surface (see, e.g., reference number 402, FIG. 4) forming a hollow cavity extending therethrough to permit fluid communication with a hose 102, as described above.

The male piece 204 includes an inner sealing member 210 disposed on, over, and/or around the male piece 204. The inner sealing member 210 may include an annular member, such as a single thread O-ring (e.g., an axial swivel O-ring), a gasket, and/or the like, by which faces, spaces, and/or surfaces adjacent to an end 212 of the male piece 204 may be sealed for the sealing of hydraulic fluid in the coupling device 200.

The male piece 204 includes an external recessed surface portion 214 that, when the male piece 204 is inserted into the female piece 202, aligns with the open surfaces 208 to form an opening (see, e.g., reference number 404, FIG. 4) through which a leg 216 of a staple 218 can be inserted to couple the male piece 204 and the female piece 202 together, in a manner similar to that as shown in FIG. 1.

As shown in FIG. 2, the external recessed surface portion 214 includes a first cavity 220 and a second cavity 222 configured to prevent a first edge 224 and a second edge 226, respectively, from contacting the external recessed surface portion 214, as described elsewhere herein.

FIG. 3 is a diagram of an example sectional view 300 of the coupling device 100 of FIG. 1. FIG. 3 illustrates a sectional view of the male piece 106 coupled to the female piece 104. As shown in FIG. 3, the male piece 106 includes an interior surface 302 forming a hollow cavity to permit fluid to flow therethrough. As further shown in FIG. 3, the male piece 106 includes a pair of external recessed surface portions 304 that, when the male piece 106 is inserted into the female piece 104, aligns with open surfaces 110 of the female piece 104 to form an opening 308 through which a leg 112 of a staple 114 can be inserted to couple the male piece 106 and the female piece 104 together.

In some implementations, each external recessed surface portion 304 includes a recessed portion or cavity 306. As shown in FIG. 3, the cavity 306 may be formed on an end of the external recessed surface portion 304 (e.g., adjacent to a perimeter) and extends towards a center of the external recessed surface portion 304. The cavity 306 may be positioned so that a portion (e.g., an edge 310) of the leg 112 of the staple 114 is prevented from contacting the external recessed surface portion 304 when the leg 112 of the staple 114 extends through the opening 308 to couple the male piece 106 and the female piece 104 together.

In some implementations, the cavity 306 may extend along, or have a width of about one-tenth, one-fifth, one-third, two-fifths, or one-half of a width of the external recessed surface portion 304. For example, the external recessed surface portion 304 may have a width of approximately 9.1 mm. The cavity 306 may have a width of approximately 3.0 mm or about one-third of the width of the external recessed surface portion 304. Alternatively, and/or additionally, the cavity 306 may extend along, or have a width of about one-tenth, one-fifth, one-third, two-fifths, or one-half of a width of the leg 112 of the staple 114.

The cavity 306 may have a length of, or extend along, an entire length of the external recessed surface portion 304. For example, the cavity 306 may form an annular cavity along a circumference of the external recessed surface portion 304.

In some implementations, the depth of the cavity 306 (e.g., a distance from a highest point 312 of the cavity 306 to a lowest point 314 of the cavity 306) may be sufficient to prevent the edge 310 of the leg 112 of the staple 114 from contacting the external recessed surface portion 304 while maintaining a structural integrity of the male piece 106. For example, the depth of the cavity 306 may be dependent upon a material from which the male piece 106 is formed and/or a maximum pressure exerted by a fluid flowing through the cavity formed by the interior surface 302. In some implementations, the cavity 306 may have a depth that is between about 0.5 mm and 2.0 mm. For example, the cavity 306 may have a depth of about 1.0 mm.

In some implementations, the cavity 306 may be formed by a machining process. For example, each external recessed surface portion 304 may be machined with a one-half of a “W” profile groove, a “U” profile, a “V” profile, a square shape, and/or another shape rather than a flat profile groove, to form the cavity 306.

In some implementations, the cavity 306 may be formed by increasing a height of a portion of the external recessed surface portion 304 to cause a remaining portion of the external recessed surface portion 304 to form the cavity 306. For example, a machining process may be used to remove material from, and/or increase a depth of, an entire portion of the external recessed surface portion 304. A process (e.g., gluing, welding, and/or another suitable process) may then be used to attach additional material to at least a center portion of the external recessed surface portion 304 to form the cavity 306.

FIG. 4 is a diagram of an example sectional view 400 of the coupling device 200 of FIG. 2. FIG. 4 illustrates a sectional view of the male piece 204 coupled to the female piece 202. As shown in FIG. 4, the male piece 204 includes an interior surface 402 forming a hollow cavity to permit fluid to flow therethrough. As further shown in FIG. 4, the male piece 204 includes a pair of external recessed surface portions 214 that, when the male piece 204 is inserted into the female piece 202, aligns with open surfaces 208 of the female piece 202 to form an opening 404 through which a leg 216 of a staple 218 can be inserted to couple the male piece 204 and the female piece 202 together.

In some implementations, each of the external recessed surface portions 214 may include a plurality of cavities. For example, as shown in FIG. 4, each external recessed surface portion 214 may include a first cavity 220 and a second cavity 222. The first cavity 220 and the second cavity 222 may cause a profile of a cross-section of the external recessed surface portion 214 to have a substantially W-shaped profile, a substantially double U-shaped profile, and/or another shape that prevents the first edge 224 and the second edge 226 of the leg 216 of the staple 218 from contacting the external recessed surface portion 214. For example, each external recessed surface portion 214 may be machined with a “W” profile groove, rather than a flat profile groove, to form the first cavity 220 and the second cavity 222.

In some implementations, the first cavity 220 may be formed on a first end of the external recessed surface portion 214 (e.g., adjacent to a perimeter) and extend towards a center of the external recessed surface portion 214. The first cavity 220 may be positioned such that a first portion (e.g., the first edge 224) of the leg 216 of the staple 218 is prevented from contacting the external recessed surface portion 214 when the leg 216 of the staple 218 extends through the opening 404 to couple the male piece 204 and the female piece 202 together.

In some implementations, the depth of the first cavity 220 may be sufficient to prevent the first edge 224 of the leg 216 of the staple 218 from contacting the external recessed surface portion 214 while maintaining a structural integrity of the male piece 204. For example, the depth of the first cavity 220 may be dependent upon a material from which the male piece 204 is formed and/or a maximum pressure exerted by a fluid flowing through the cavity formed by the interior surface 402. In some implementations, the first cavity 220 may have a depth that is between about 0.5 mm and 2.0 mm. For example, the first cavity 220 may have a depth of about 1.0 mm.

In some implementations, a width of the first cavity 220 may be one-third a width of the external recessed surface portion 214. Alternatively, and/or additionally, the first cavity 220 may extend along, or have a width of about one-tenth, one-fifth, one-third, two-fifths, or one-half of a width of the leg 216 of the staple 218.

The first cavity 220 may have a length of, or extend along, an entire length of the external recessed surface portion 214. For example, the first cavity 220 may form an annular cavity along a circumference of the external recessed surface portion 214.

In some implementations, the second cavity 222 may be formed on a second end of the external recessed surface portion 214 (e.g., adjacent to a perimeter), that is opposite to the first end, and may extend towards a center of the external recessed surface portion 214. The second cavity 222 may be positioned such that a second portion (e.g., the second edge 226) of the leg 216 of the staple 218 is prevented from contacting the external recessed surface portion 214 when the leg 216 of the staple 218 extends through the opening 404 to couple the male piece 204 and the female piece 202 together.

In some implementations, the depth of the second cavity 222 may be sufficient to prevent the second edge 226 of the leg 216 of the staple 218 from contacting the external recessed surface portion 214 while maintaining a structural integrity of the male piece 204. For example, the depth of the second cavity 222 may be dependent upon a material from which the male piece 204 is formed and/or a maximum pressure exerted by a fluid flowing through the cavity formed by the interior surface 402. In some implementations, the second cavity 222 may have a depth that is between about 0.5 mm and 2.0 mm. For example, the second cavity 222 may have a depth of about 1.0 mm.

In some implementations, a depth of the second cavity 222 may be about the same as a depth of the first cavity 220. In some implementations, the depth of the second cavity 222 may be greater than the depth of the first cavity 220. In some implementations, the depth of the second cavity 222 may be less than the depth of the first cavity 220.

In some implementations, a width of the second cavity 222 may be one-third a width of the external recessed surface portion 214. In some implementations, the width of the second cavity 222 may be about the same as the width of the first cavity 220. In some implementations, the width of the second cavity 222 may be greater than the width of the first cavity 220. In some implementations, the width of the second cavity 222 may be less than the width of the first cavity 220. Alternatively, and/or additionally, the second cavity 222 may extend along, or have a width of about one-tenth, one-fifth, one-third, two-fifths, or one-half of a width of the leg 216 of the staple 218.

The second cavity 222 may have a length of, or extend along, an entire length of the external recessed surface portion 214. For example, the second cavity 222 may form an annular cavity along a circumference of the external recessed surface portion 214.

In some implementations, the external recessed surface portion 214 may include a center portion 406. The center portion 406 may be configured to retain the leg 216 of the staple 218 in the opening 404 and may be positioned above the first cavity 220 and/or the second cavity 222. In some implementations, the center portion 406 may contact a middle portion 408 of the leg 216 of the staple 218 along a length of the external recessed surface portion 214. Alternatively, and/or additionally, the center portion 406 may contact a different portion of the leg 216. In some implementations, a width of the center portion 406 is about one-third a width of the external recessed surface portion 214. In some implementations, the width of the center portion 406 is about the same as the width of the first cavity 220 and/or the width of the second cavity 222. In some implementations, the width of the center portion 406 is less than the width of the first cavity 220 and/or the width of the second cavity 222. In some implementations, the width of the center portion 406 is greater than the width of the first cavity 220 and/or the width of the second cavity 222. Alternatively, and/or additionally, the first cavity 220 may extend along, or have a width of about one-tenth, one-fifth, one-third, two-fifths, or one-half of a width of the leg 216 of the staple 218.

The center portion 406 may have a length of, or extend along, an entire length of the external recessed surface portion 214. For example, the center portion 406 may form an annular ridge along a circumference of the external recessed surface portion 214.

### INDUSTRIAL APPLICABILITY

The disclosed coupling device may be used with any machine in which fluid power transfer is provided. In operation, the male piece of the coupling device may be received by, and connected to, the female piece to form the coupling device.

In some implementations, the male piece has an improved external recessed surface portion, or groove profile. When connected to a female piece of the coupling device, the improved external recessed surface portion prevents at least one edge of a leg of a staple from contacting the external recessed surface portion. In this way, a stress concentration is minimized during bending and contact positions for staple retention are maintained. By minimizing the stress concentration during bending, wear and fatigue is reduced relative to a male piece of a coupling device having a flat groove profile (e.g., an external recessed surface portion having a flat surface). A reduction in wear and fatigue may result in a reduction of one or more costs such as, for example, a cost associated with replacing the male piece of the coupling device, a cost associated with an amount of down time resulting from the replacement of the male piece, and/or the like.

The foregoing disclosure provides illustration and description, but is not intended to be exhaustive or to limit the implementations to the precise form disclosed. Modifications and variations may be made in light of the above disclosure or may be acquired from practice of the implementations. It is intended that the specification be considered as an example only, with a true scope of the disclosure being indicated by the following claims and their equivalents. Even though particular combinations of features are recited in the claims and/or disclosed in the specification, these combinations are not intended to limit the disclosure of various implementations.

What is claimed is:

1. A connection, comprising:
a male piece of a detachable hose coupling configured to permit insertion into a female piece of the detachable hose coupling,
wherein the male piece includes:
a longitudinal axial open area extending through the male piece to permit a fluid to be communicated through the male piece, and
an external recessed surface portion,
wherein, when the male piece is inserted into the female piece, the external recessed surface portion is aligned with an open surface extending through the female piece to form an opening extending through the detachable hose coupling,
wherein the opening is configured to allow a leg of a staple to be inserted through the opening to couple the male piece and the female piece together, and
wherein the external recessed surface portion forms a cavity under a portion of the leg of the staple to prevent an edge of the leg of the staple from contacting the external recessed surface portion when the leg of the staple extends through the opening to couple the male piece and the female piece together.

2. The connection of claim 1, wherein the external recessed surface portion forms another cavity under another portion of the leg of the staple to prevent another edge of the leg of the staple from contacting the external recessed surface portion when the leg of the staple extends through the opening to couple the male piece and the female piece together.

3. The connection of claim 1, wherein the external recessed surface portion is configured to allow only a center portion of the leg of the staple to contact the external recessed surface portion when the leg of the staple extends through the opening to couple the male piece and the female piece together.

4. The connection of claim 1, wherein a profile of the external recessed surface portion comprises a W-shaped profile.

5. The connection of claim 1, wherein the cavity formed under the portion of the leg of the staple extends along one-third of a width of the leg of the staple.

6. The connection of claim 1, wherein a portion of the leg of the staple contacting the external recessed surface portion retains the leg of the staple within the opening when the fluid is communicated through the male piece.

7. The connection of claim 1, wherein the detachable hose coupling comprises a staple-lock hydraulic coupling.

8. A male piece of a coupling device, comprising:
a cylindrical body having an interior surface and an exterior surface,
wherein the interior surface forms a longitudinal axial open area extending from a first end of the cylindrical body to a second end of the cylindrical body to permit a fluid to be communicated through the male piece,
wherein the exterior surface includes an external recessed surface portion, and
wherein the external recessed surface portion is shaped to prevent an edge of a leg of a staple from contacting the external recessed surface portion when the male piece is coupled to a female piece of the coupling device.

9. The male piece of claim 8, wherein the external recessed surface portion forms a first cavity to prevent the edge of the leg of the staple from contacting the external recessed surface portion when the leg of the staple is inserted into the external recessed surface portion.

10. The male piece of claim 9, wherein the external recessed surface portion forms a second cavity to prevent another edge of the leg of the staple from contacting the external recessed surface portion when the leg of the staple is inserted into the external recessed surface portion.

11. The male piece of claim 9, wherein the first cavity extends along one-third of a width of the leg of the staple.

12. The male piece of claim 8, wherein the external recessed surface portion is configured to allow only a center portion of the leg of the staple to contact the external recessed surface portion when the leg of the staple is inserted into the external recessed surface portion.

13. The male piece of claim 8, wherein a portion of the leg of the staple contacting the external recessed surface portion is sufficient to retain the leg of the staple within the external recessed surface portion when the fluid is communicated through the male piece.

14. The male piece of claim 8, wherein the male piece is part of a staple-lock hydraulic coupling.

15. A detachable hose coupling, comprising:
a male piece configured to permit insertion into a female piece of the detachable hose coupling,
wherein the male piece includes:
a longitudinal axial open surface extending through the male piece to permit a fluid to be communicated through the male piece, and
an external recessed surface portion,
wherein, when the male piece is inserted into the female piece, the external recessed surface portion is aligned with an open surface extending through the female piece to form an opening extending through the detachable hose coupling,
wherein the opening is configured to allow a leg of a staple to be inserted through the opening to couple the male piece and the female piece together, and
wherein the external recessed surface portion forms a recessed area under a portion of the leg of the staple to prevent a first edge of the leg of the staple from contacting the external recessed surface portion when the leg of the staple extends through the opening to couple the male piece and the female piece together.

16. The detachable hose coupling of claim 15, wherein the external recessed surface portion forms another recessed area under another portion of the leg of the staple to prevent another edge of the leg of the staple from contacting the external recessed surface portion when the leg of the staple extends through the opening.

17. The detachable hose coupling of claim 15, wherein a center portion of the external recessed surface portion is configured to allow only a center portion of the leg of the staple to contact the external recessed surface portion when the leg of the staple extends through the opening.

18. The detachable hose coupling of claim 15, wherein a profile of the external recessed surface portion comprises a W-shaped profile.

19. The detachable hose coupling of claim 15, wherein the recessed area formed under the portion of the leg of the staple extends along one-third of a width of the external recessed surface portion.

20. The detachable hose coupling of claim 15, wherein a center portion of the leg of the staple contacting the external recessed surface portion is configured to retain the leg of the staple within the opening when the fluid is communicated through the male piece.
